(19) United States
(12) Patent Application Publication
(10) Pub. No.: US 2004/0156214 A1
(43) Pub. Date: Aug. 12, 2004

(54) 3D Christmas light frame

(76) Inventor: Wei-Jen Tseng, Hsinchu (TW)

Correspondence Address: Jackson Walker L.L.P., Suite 2100, 112 E. Pecan Street, San Antonio, TX, 78205, US

(21) Appl. No.: 10/360,377

(22) Filed: Feb. 6, 2003

(51) Int. Cl. F21S 4/00

(52) U.S. Cl. 362/565; 362/566

(57) ABSTRACT

A Christmas light frame includes a plane base composed of two parallel formed rods and a base securely connected to the two parallel formed rods to cover an area enclosed by the two rods, and a three dimensional secondary frame integrally formed on top of the plane base. The three dimensional secondary frame has two mutually parallel, secondary rods integrally formed with the two rods of the plane base. The secondary rods extend from distal ends of the plane base and join together. The parallel rods and the secondary rods both have multiple positioning devices including multiple pairs of cutouts defined in the two rods and multiple pairs of clamping rods corresponding to the cutouts to position the Christmas light bulbs in a passage respectively defined between the parallel rods and the secondary rods.

### BACKGROUND OF THE INVENTION

1. Field of the Invention

The present invention relates to a Christmas light frame, and more particularly to a three dimensional Christmas light frame having therein multiple light bulbs so as to present a vivid picture-like ornamental effect.

2. Description of Related Art

Conventional Christmas lights are normally hung on the roofs or trees to decorate the house and increase the festival environment. Because the roofs or trees are not designed to have Christmas lights hung thereon, naturally, the operator will have put extra effort to straighten or to make tidy the electrical wires as well as the light bulbs.

In order to avoid the aforementioned shortcoming, a Christmas light frame (70) is presented in FIG. 7. The Christmas light frame (70) includes multiple plates (71) each provided with a passage (711) defined along a contour of the plate (71). The multiple plates (71) are pivotally connected to a central shaft (73) and each plate (71) has a positioning rod (713) for positioning each of the planetary plates on a surface. Although the Christmas light frame (70) does provide a way to straighten the electrical wire and the Christmas light bulbs, the light from the conventional Christmas light frame (70) is not focused, instead, the light from the conventional Christmas light frame (70) scatters in all directions. Because the conventional Christmas light frame (70) can not focus the light, the operator will have to use more light bulbs to reach the glamorous effect. Besides, as the conventional Christmas light frame (70) presents a two dimensional ornamental effect, there is not much variation available for this type of Christmas light frame. Naturally, the festival effect is limited.

To overcome the shortcomings, the present invention tends to provide an improved Christmas light frame to mitigate and obviate the aforementioned problems.

### SUMMARY OF THE INVENTION

The primary objective of the present invention is to provide an improved Christmas light frame having a plane base with multiple distal ends and a three dimensional secondary frame having multiple extensions extending from the distal ends of the plane base and joined together. The 3D secondary frame has a passage defined therein to receive Christmas light bulbs so that the light is focused to enhance the ornamental effect.

Another objective of the present invention is that a reflection foil is added to a side face of the plane base to further increase the ornamental effect.

Another objective of the present invention is that the plane base is composed of two parallel rods and a base securely connected to the two parallel rods to cover the area enclosed by the two parallel rods. The 3D secondary frame also comprises two mutually parallel, secondary rods integrally formed with the two parallel rods. The secondary rods extend from distal ends of the plane base and join together. The parallel rods and the secondary rods both have multiple positioning devices to position the Christmas light bulbs respectively in the parallel rods and the secondary rods

Another objective of the present invention is to provide an improved Christmas light frame having a plane base with a reflection foil securely attached to opposite sides of the plane base and two three dimensional secondary frames respectively formed on a corresponding side of the plane base.

Still another objective of the present invention is to provide an improved Christmas light frame having a pyramidal base with four secondary pyramidal extensions formed on a respective side face of the pyramidal base. Each of the pyramidal base and the secondary pyramidal extension are provided with passages defined along a contour of the pyramidal base and the secondary pyramidal extension respectively to receive therein Christmas light bulbs.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the Christmas light frame of the present invention;

FIG. 2 is a perspective view of a second embodiment of the Christmas light frame of the present invention;

FIG. 3 is an exploded perspective view of the Christmas light frame in FIG. 2;

FIG. 4 is an enlarged perspective view of a portion of the Christmas light frame in FIG. 2;

FIG. 5 is a perspective view of a third embodiment of the Christmas light frame of the present invention;

FIG. 6 is a perspective view of a fourth embodiment of the Christmas light frame of the present invention; and

FIG. 7 is a perspective view of a conventional Christmas light frame.

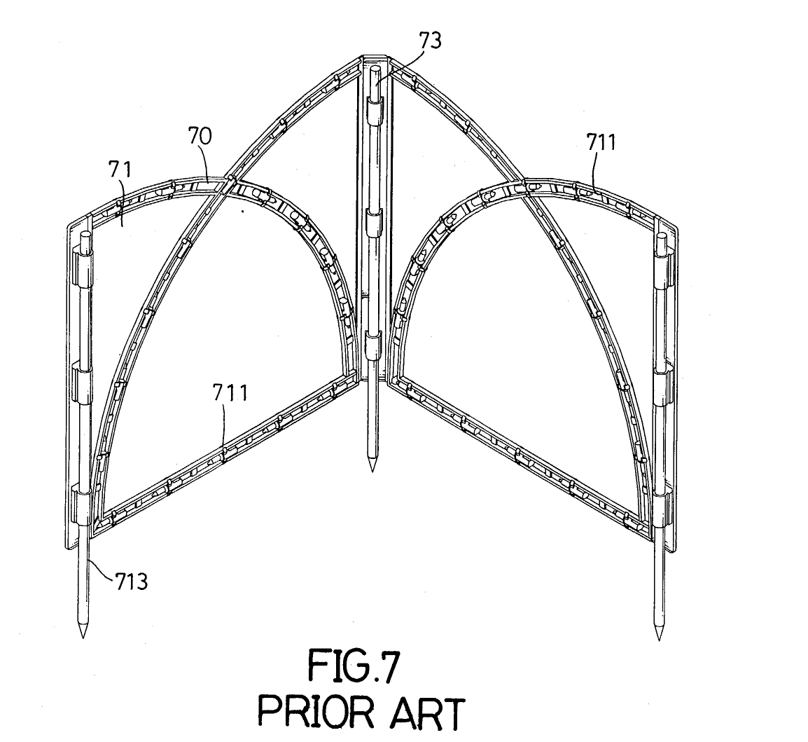

### DETAILED DESCRIPTION OF THE PREFERRED EMBODIMENT

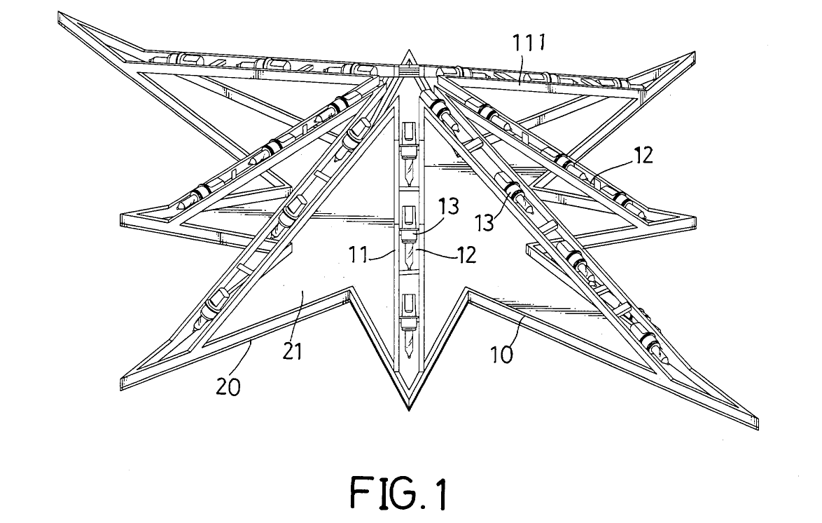

With reference to FIG. 1, a Christmas light frame in accordance with the present invention has a plane base (10) with multiple distal ends and a three dimensional secondary frame (11) having multiple extensions (111) extending from the distal ends of the plane base (10) and joined together. The 3D secondary frame (11) has a passage (12) defined therein to receive Christmas light bulbs (13) so that the light is focused to enhance the ornamental effect. Furthermore, a pad (20) is attached to a top face of the plane base (10) and has a reflection foil (21) securely attached to a top face of the pad (20). Therefore, when the Christmas light bulbs (13) are lit, the light from the Christmas light bulbs (13) is able to be reflected by the reflection foil (21) so that the ornamental effect of the Christmas light frame of the present invention is increased.

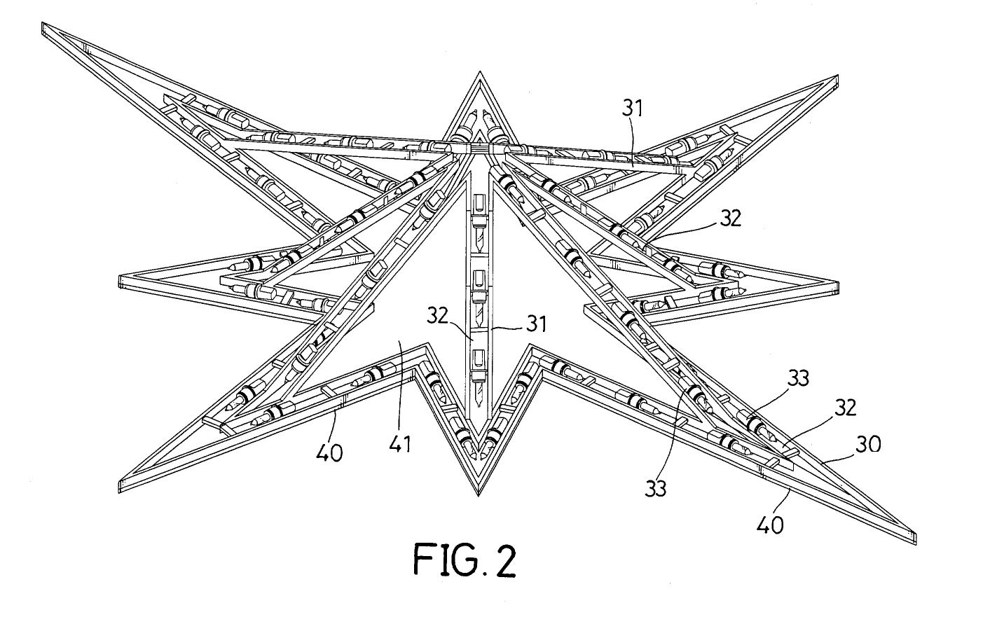

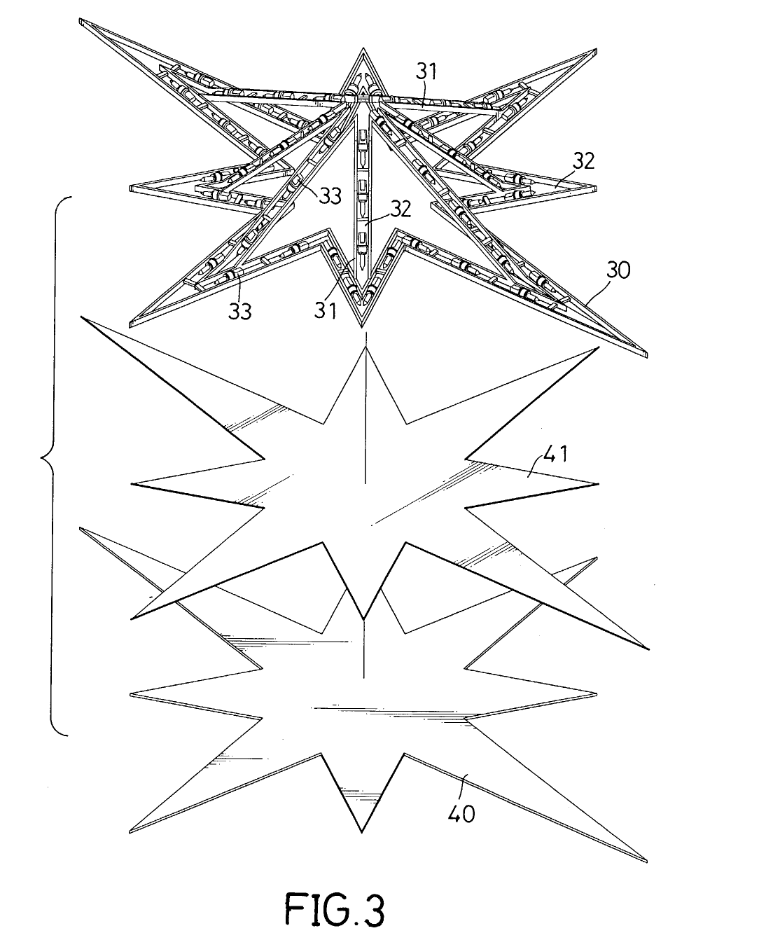

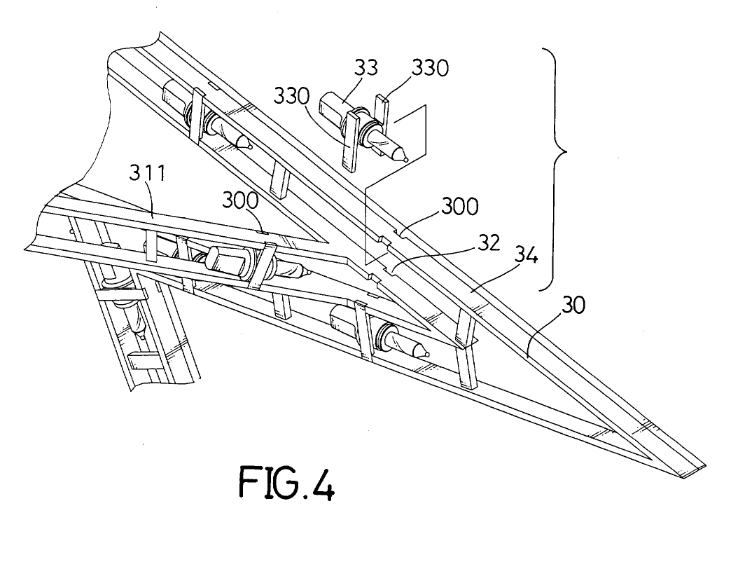

With reference to FIGS. 2, 3 and 4, a second embodiment of the Christmas light frame of the present invention is shown and has a plane base (30) and a three dimensional secondary frame (31) integrally formed on top of the plane base (30). The plane base (30) is composed of two parallel formed rods (34) and a base (40) securely connected to the two parallel formed rods (34) to cover the area enclosed by the two rods (34). The 3D secondary frame (31) also comprises two mutually parallel, secondary rods (311) integrally formed with the two rods (34) of the plane base (30). The secondary rods (311) extend from distal ends of the plane base (30) and are joined together. The parallel rods (34) and the secondary rods (311) both have multiple positioning devices including multiple pairs of cutouts (300) defined in the two rods (34) and multiple pairs of clamping rods (330) corresponding to the cutouts (300) to position the Christmas light bulbs (33) in a passage (32) respectively defined between the parallel rods (34) and the secondary rods (311).

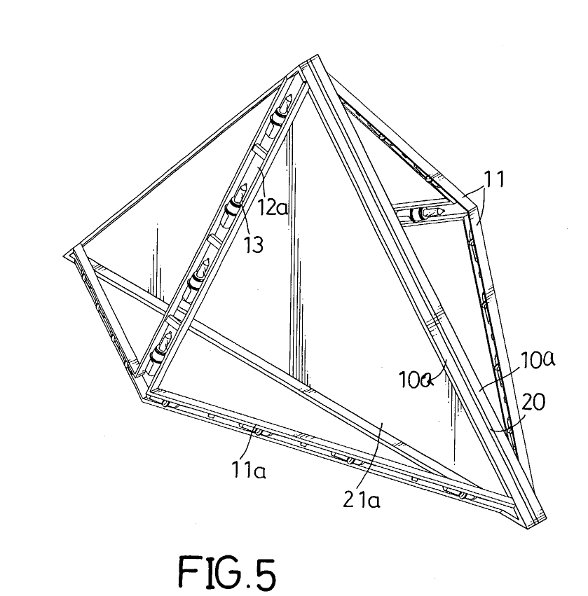

With reference to FIG. 5, another embodiment of the present invention is to provide an improved Christmas light frame having a plane base (10a) with a reflection foil (21a) securely attached to opposite sides of the plane base (10a) and two three dimensional secondary frames (11a) respectively formed on the two opposite sides of the base plane (10a). Each of the two three dimensional secondary frames (11a) has a passage (12a) defined therein for receiving Christmas light bulbs (13).

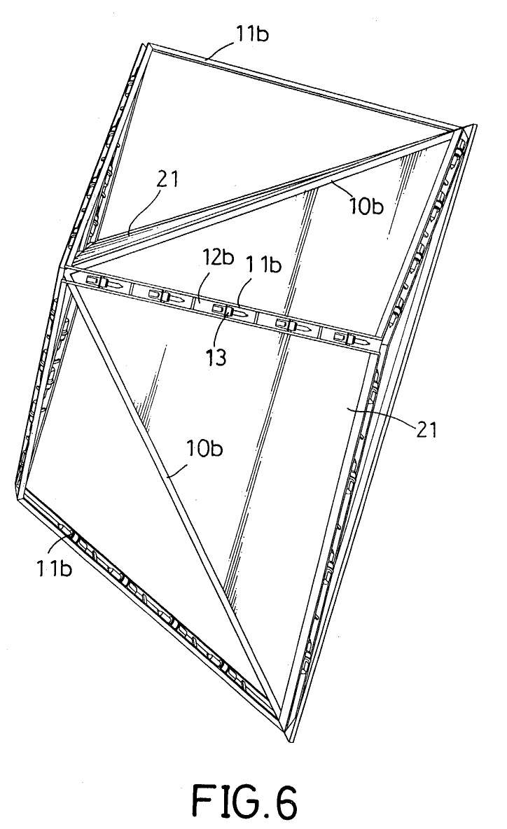

With reference to FIG. 6, another embodiment of the present invention is to provide an improved Christmas light frame having a pyramidal base (10b) with four reflection foils (21) securely attached to four sides of the pyramidal base (10b) and four secondary pyramidal extensions (11b) formed on a respective side face of the pyramidal base (10b). Each of the secondary pyramidal extensions (11b) is provided with a passage (12b) defined along a contour of the secondary pyramidal extension (111b) to receive therein Christmas light bulbs (13).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A Christmas light frame comprising:
a plane base composed of two parallel formed rods and a base securely connected to the two parallel formed rods to cover an area enclosed by the two rods; and
a three dimensional secondary frame integrally formed on top of the plane base, wherein the three dimensional secondary frame comprises two mutually parallel, secondary rods integrally formed with the two rods of the plane base, the secondary rods extend from distal ends of the plane base and join together, the parallel rods and the secondary rods both have multiple positioning devices including multiple pairs of cutouts defined in the two rods and multiple pairs of clamping rods corresponding to the cutouts to position the Christmas light bulbs in a passage respectively defined between the parallel rods and the secondary rods.

2. A Christmas light frame comprising:
a plane base with two reflection foils attached to opposite side faces of the plane base; and
two three dimensional secondary frames respectively formed on the opposite side faces of the plane base, wherein each three dimensional secondary frame has multiple extensions extending from distal ends of the plane base and joining together, wherein each of the plane base and the extensions of the three dimensional secondary frame have a passage defined along a contour of the plane base and the extensions of the three dimensional secondary frame to receive therein Christmas light bulbs.

3. A Christmas light frame comprising:
a pyramidal base with four reflection foils securely and respectively attached to four sides of the pyramidal base; and
four secondary pyramidal extensions formed on respective side face of the pyramidal base, wherein each of the secondary pyramidal extensions is provided with a passage defined along a contour of the secondary pyramidal extension to receive therein Christmas light bulbs.
